(19) United States
(12) Patent Application Publication
(10) Pub. No.: US 2004/0027970 A1
(43) Pub. Date: Feb. 12, 2004

(54) Optical pickup and optical recording and/or reproducing apparatus using the same

(75) Inventors: Dong-Ryeol Lee, Seoul (KR); Ju-Hyung Lee, Suwon-si (KR); Pyong-Yong Seong, Seoul (KR); Young-Kug Yoon, Seongnam-si (KR); Kun-Soo Kim, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-city (KR)

(21) Appl. No.: 10/617,855

(22) Filed: Jul. 14, 2003

(30) Foreign Application Priority Data
Aug. 12, 2002 (KR) 2002-47511

(51) Int. Cl. G11B 7/135

(52) U.S. Cl. 369/112.08; 369/112.28; 369/112.1

(57) ABSTRACT

An optical pickup condenses a light emitted from a light source using an objective lens and irradiates the light on an optical recording medium to record data on the optical recording medium and/or to reproduce the data recorded on the optical recording medium. The optical pickup includes an optical element adjusting a convergence and/or a divergence of the light emitted from the light source and proceeded to the objective lens.

### CROSS-REFERENCE TO RELATED APPLICATIONS

This application claims the priority of Korean Patent Application No. 2002-47511, filed on Aug. 12, 2002, in the Korean Intellectual Property Office, the disclosure of which is incorporated herein in its entirety by reference.

### BACKGROUND OF THE INVENTION

1. Field of the Invention

The present invention relates to an optical pickup and an optical recording and/or reproducing apparatus using the same, and more particularly, to an optical pickup capable of adjusting a convergent light and/or a divergent light and an optical recording and/or reproducing apparatus using the same.

2. Description of the Related Art

Referring to FIG. 1, a divergent light emitted from a light source 1, for example, a semiconductor laser, can be converted into a parallel light by way of a collimating lens 3.

In order to make the divergent light emitted from the light source 1 into the parallel light after passing through the collimating lens 3, a distance between a radiant point of the semiconductor laser 1 and the collimating lens 3 must be equal to a flange back length of the collimating lens 3. Here, in a case of using a thick collimating lens 3, because a focal length occupies up to a middle portion of the thick lens, it is difficult to define the focal length. Thus, the term “flange back length” is referred to as a general mechanical length. The flange back length of the collimating lens 3 is referred to as a back focal length of the collimating lens 3, where optical components are not disposed between the radiant point of the light source 1 and the collimating lens 3. However, the term flange back length may be used even in a case where the optical components are disposed between the radiant point of a light source 1 and the collimating lens 3.

As can be seen from FIG. 1, if the distance between the radiant point of the light source 1 and the collimating lens 3 is longer than the flange back length, the light passed through the collimating lens 3 becomes a convergent light. On the contrary, if the distance between the radiant point of the light source 1 and the collimating lens 3 is shorter than the flange back length, the light passed through the collimating lens 3 becomes the divergent light.

As described above, the distance between the radiant point of the light source 1 and the collimating lens 3 affects the convergence and/or the divergence of the light.

Because an optical pickup includes various optical components, when the optical components are aligned and assembled optically, a manufacturing tolerance of the optical components themselves and an assembly tolerance between the optical components occur. Such tolerances are accumulated throughout the optical pickup and, thus, optical aberration is generated in the optical pickup due to accumulation of the tolerances.

The optical pickup including the collimating lens 3 having a long focal length is assembled such that the optical components are disposed at desirable positions on a mechanical structure, and the optical components are fixed using adhesive means, such as an adhesive. Because parallelism of the light emitted from the light source 1 falls within an allowable value within a marginal value of the assembly tolerance in the optical pickup assembled as described above, the distance between the light source 1 and the collimating lens 3 does not need to be adjusted.

Meanwhile, an optical recording and/or reproducing apparatus for a notebook computer uses a slim optical pickup, which must include a collimating lens having a short focal length in order to satisfy a mechanical distance of the slim optical pickup.

Even if the distance between the light source 1 and the collimating lens 3 slightly deviates from the flange back length of the collimating lens 3 in the optical pickup including the collimating lens 3 having the short focal length, causing the parallelism of the light emitted from the light source 1 to be very poor, the assembly tolerance of the optical pickup must be managed strictly. Thus, the management of the convergence and/or the divergence of the light, that is, the management of the parallel light, is necessary for the optical pickup including the collimating lens 3 having a short focal length.

In a case where the optical pickup includes a beam shaping device which makes a shape of the light beam emitted from the light source 1, when convergent light or divergent light, not parallel light, passes through the beam shaping device, the optical aberration of the optical pickup may deteriorate considerably. Thus, the management of the convergence and/or the divergence of the light, that is, the management of the parallel light is necessary for the optical pickup including the beam shaping device.

Accordingly, in the optical pickup which is necessary for management of specific aberration characteristics, such as an optical system which greatly generates the optical aberration due to the convergence and/or the divergence of the light and includes the collimating lens 3 having the short focal length or the beam shaping device, the light passing through the collimating lens 3 must be the parallel light or close enough to the parallel light so that optical aberration falls within an allowable value within a marginal value of the assembly tolerance of the optical pickup.

The management of the parallel light is achieved by disposing the optical components at desirable positions on a mechanical structure, for example, by changing the position of the collimating lens 3 along an optical axis in a state where the light source 1 is fixed at a desirable position and by adjusting the distance between the radiant point of the light source 1 and the collimating lens 3.

However, adjusting the position of the collimating lens 3 along the optical axis for the management of the parallel light makes a process for assembling the optical pickup complex, because adjusting the position of the collimating lens 3 along the optical axis is carried out in a state where a central axis of the collimating lens 3 is parallel and identical to the optical axis. In reality, it is a difficult job to move the collimating lens 3 in the state where the central axis of the collimating lens 3 is parallel to the optical axis. Thus, the adjustment of the convergence and/or the divergence of the light due to adjustments in position of the collimating lens 3 makes a process for assembling the optical pickup complex, resulting in an increase in a cost of manufacturing the optical pickup.

### SUMMARY OF THE INVENTION

According to an aspect of the present invention, there is provided an optical pickup in which adjustment of a convergence and/or divergence of light is easily accomplished and an optical recording and/or reproducing apparatus using the same.

According to an aspect of the present invention, there is provided an optical pickup which condenses light emitted from a light source using an objective lens and irradiates the light on an optical recording medium in order to record data on the optical recording medium and/or reproduce the data recorded on the optical recording medium. The optical pickup includes an optical element for adjusting the convergence and/or the divergence of the light emitted from the light source and proceeded to the objective lens.

According to another aspect of the present invention, there is provided an optical recording and/or reproducing apparatus which records data on an optical recording medium and/or reproduces the data recorded on the optical recording medium using an optical pickup which focuses light emitted from a light source onto an objective lens and irradiates the light on the optical recording medium. The optical pickup includes an optical element to adjust a convergence and/or a divergence of light emitted from the light source and proceeded to the objective lens.

According to the present invention, the optical element may be a hologram optical element that can adjust the convergence and/or divergence of the light.

According to an aspect of the present invention, the optical pickup further includes a collimating lens, wherein the light emitted from the light source passes through the collimating lens and the optical element and is converted into a parallel light.

The collimating lens may have a focal length of 14 mm or less.

The optical pickup may have a slim structure.

The optical element may be disposed between the light source and the collimating lens 3.

The optical pickup may further include a beam shaping device, which is disposed between the collimating lens and the objective lens to shape the light.

According to an aspect of the present invention, the light source may include a plurality of light sources emitting light beams having different wavelengths and an optical element includes at least optical elements for adjusting a convergence and/or a divergence of a light beam emitted from at least one of the plurality of light sources so that an optical pickup is a compatible optical pickup that can be used in a plurality of optical recording media having different formats.

An optical pickup including an optical disc, a light source emitting a light, an objective lens focusing the light emitted from the light source and irradiating the light on the optical disc, a collimating lens making the light emitted from the light source into a parallel light and an optical element adjusting a convergence and/or a divergence of the light so that the light passing through the collimating lens and proceeding to the objective lens is a parallel light or approximate to the parallel light.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the aspects taken in conjunction with the accompanying drawings in which:

FIG. 1 shows a conventional adjustment of a convergence and/or a divergence of light according to a distance between a radiant point of a light source and a collimating lens;

FIG. 2 schematically shows a main structure of an optical pickup, according to a first aspect of the present invention;

FIG. 3 is a schematic plan view of a hologram pattern of a hologram optical element used as an optical element of FIG. 2;

FIG. 4 shows an optical structure of the optical pickup, according to a second aspect of the present invention;

FIG. 5 shows the optical structure of the optical pickup, according to a third aspect of the present invention;

FIG. 6 shows the optical structure of the optical pickup, according to a fourth aspect of the present invention; and

FIGS. 7 through 9 show examples of a beam shaping device used in an optical pickup, according to an aspect of the present invention.

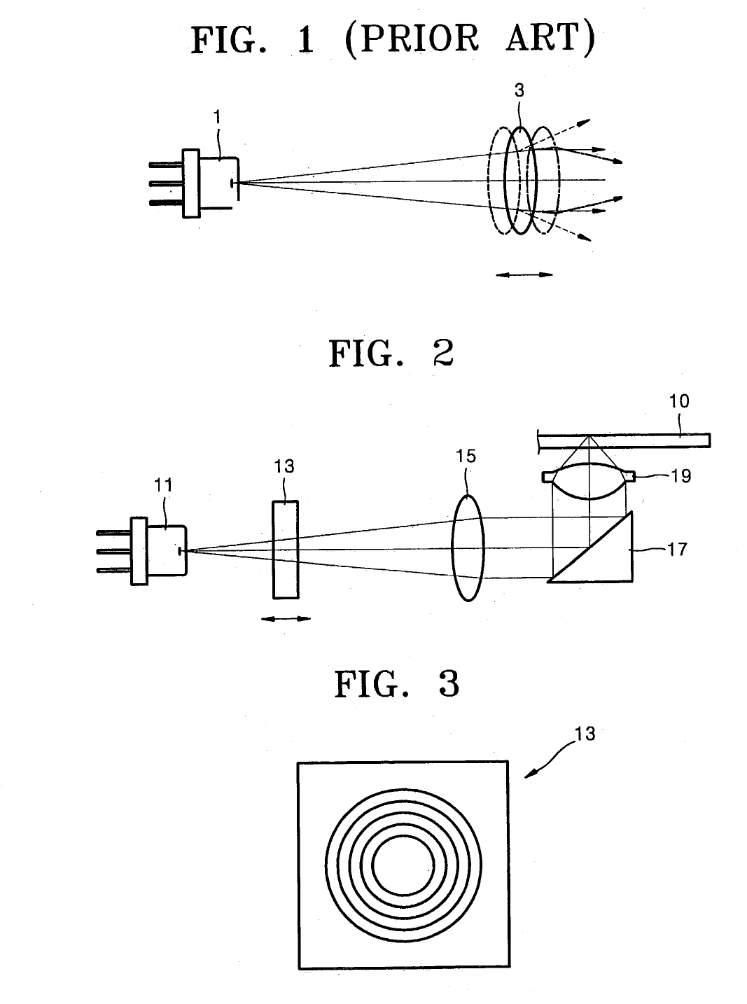

### DETAILED DESCRIPTION OF THE PREFERRED EMBODIMENTS

Reference will now be made in detail to the present aspects of the present invention, examples of which are illustrated in the accompanying drawings, wherein like reference numerals refer to the like elements throughout. The aspects are described below in order to explain the present invention by referring to the figures.

An optical recording and/or reproducing apparatus, according to an aspect of the present invention, uses an optical pickup which will be described below to record data on an optical recording medium and to reproduce the data recorded on the optical recording medium by focusing a light emitted from a light source using an objective lens and irradiating the light on the optical recording medium.

FIG. 2 schematically shows a main structure of the optical pickup, according to a first aspect of the present invention.

Referring to FIG. 2, the optical pickup, according to the first aspect of the present invention includes a light source 11, an objective lens 19 to focus a light emitted from the light source 11 and irradiating the light on an optical disc 10, a collimating lens 15 to make the light emitted from the light source 11 into a parallel light, and an optical element 13 to adjust a convergence and/or a divergence of the light. The optical pickup is used in recording data on the optical disc 10 and/or reproducing the data recorded on the optical disc 10. Reference numeral 17 represents a reflecting mirror.

A semiconductor laser, such as an edge emitting laser or a vertical cavity surface emitting laser to emit the light having a predetermined wavelength, may be used as the light source 11.

In a case where the semiconductor laser is used as the light source 11, the light source 11 emits a divergent light.

The collimating lens 15 is disposed between the light source 11 and an optical path changing device or between the optical path changing device and the objective lens 19 so that the collimating lens 15 focuses the divergent light emitted from the light source 11 and makes the light into the parallel light.

In one aspect of the present invention, the collimating lens 15 may have a short focal length, for example, a short focal length of 14 mm or less, in order to manufacture the optical pickup into a slim shape.

Because the separate optical element 13 adjusts the convergence and/or the divergence of the light in the optical pickup, according to an aspect of the present invention, the collimating lens 15 is fixed at a desirable position on a mechanical structure in a process to assemble the optical components included in the optical pickup.

The optical element 13 adjusts the convergence and/or the divergence of the light so that the light which passes through the collimating lens 15 and proceeds to the objective lens 19 is a parallel light or close to a parallel light and has a degree of parallelism within a tolerable range. The optical element 13 may be disposed between the light source 11 and the collimating lens 15.

A hologram optical element that is configured to adjust the convergence and/or the divergence of the light may be as the optical element 13. For example, in a case where the hologram optical element having a hologram pattern structure as shown in FIG. 3 is used as the optical element 13. The hologram optical element functions as a lens so that the convergence and/or the divergence of the light can be adjusted by changing a position of the hologram optical element along the optical axis.

As described above, in the optical pickup having the separate optical element 13 to adjust the convergence and/or the divergence of the light, the collimating lens 15 is fixed at a desirable position on the mechanical structure in the process of assembling the optical components, and the convergence and/or the divergence of the light is adjusted by changing a position of the optical element 13 along the optical axis.

Because the optical pickup, according to an aspect of the present invention, adjusts the convergence and/or the divergence of the light using the hologram optical element as the optical element 13, instead of adjusting the convergence and/or the divergence of the light using the collimating lens 15 as in conventional systems, a process of assembling the optical components of the optical pickup is simpler according to an aspect of the present invention, than the assembling of the optical components in the conventional systems.

Because the hologram optical element used as the optical element of the optical pickup, according to an aspect of the present invention, can be designed to be greatly insensitive to an optical alignment error compared to a general optical lens, adjusting a parallel light by changing the position of the hologram optical element 13 along the optical axis is easier than adjusting the parallel light by changing the position of the collimating lens 15 along the optical axis.

The optical pickup, according to the first aspect of the present invention, further includes an optical path changing device (not shown) which changes an optical path of the light and a light receiving optical system (not shown) which receives the light reflected from a recording surface of the optical disc 10.

The optical path changing device and the light receiving optical system are not shown in FIG. 2 for convenience, in order to show that the optical pickup has the collimating lens 15 having a short focal length of, for example, 14 mm or less, making the optical pickup suitable for a slim optical recording and/or reproducing apparatus.

The optical path changing device and the light receiving optical system of optical pickups, according to second and third aspects of the present invention can be applied as those of the optical pickup, according to the first aspect of the present invention. Thus, the optical path changing device and the light receiving optical system will not be described, but are shown in the first aspect of the present invention.

Meanwhile, the wavelength of the light emitted from the light source 11, the number of light sources 11, and the numerical aperture of the objective lens 19, etc., may be suitably changed depending on the optical recording and/or reproducing apparatus using the optical pickup.

For example, the optical pickup, according to an aspect of the present invention, includes the single light source 11 and the objective lens 19 having the proper numerical aperture so that the optical pickup may be applied to one family of optical discs or a plurality of types of optical discs having different formats. That is, the optical pickup, according to an aspect of the present invention, can be configured to a compatible optical pickup that can be applied to a plurality of families of optical discs.

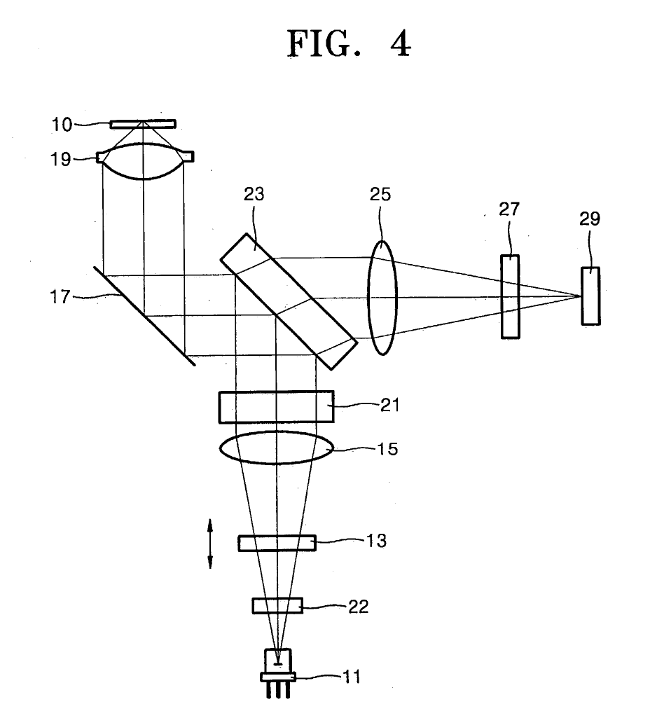

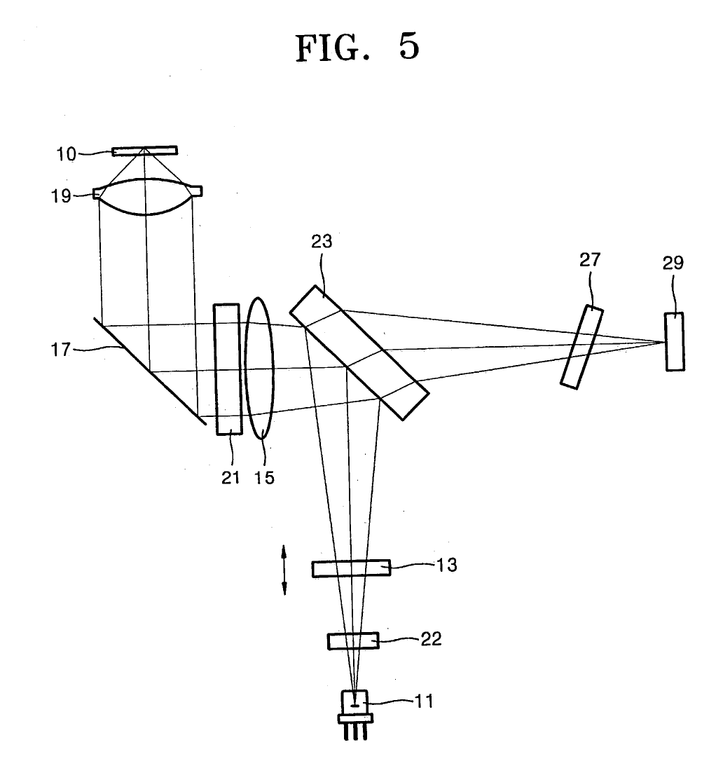

Specifically, referring to FIGS. 4 and 5, the optical pickup, according to an aspect of the present invention, includes a single light source 11 which emits the light having a wavelength of, for example, 655 nm, and an objective lens 19 having a numerical aperture of 0.6 or 0.65 so that the optical pickup can be configured to be applied to DVD family optical discs or compatibly with both the DVD family optical discs and CD family optical discs.

FIG. 4 shows an optical structure of the optical pickup, according to a second aspect of the present invention. In the second aspect of the present invention, the optical element 13 and the collimating lens 15 are disposed between the light source 11 and an optical path changing device, that is, a plate beam splitter 23. The optical pickup includes a beam shaping device 21 for shaping the light. In FIG. 4, the same reference numerals as those in FIG. 2 represent the same components, and, thus, their descriptions will be omitted.

The beam shaping device 21 is disposed on the an optical path of the light converted into the parallel light after passing though the optical element 13 and the collimating lens 15.

As shown in FIG. 4, in a case where the collimating lens 15 and the beam shaping device 21 are disposed between the light source 11 and the plate beam splitter 23, the light which has been reflected from the optical disc 10, passed through the plate beam splitter 23, and proceeded to the light receiving optical system becomes the parallel light in a beam shaping state.

Thus, a condensing lens 25 for condensing the parallel light and a concave lens 27, which is a so-called Yo-lens that is used to form a light spot having a proper size on a photodetector 29, may be disposed between the plate beam splitter 23 and the photodetector 29.

In FIG. 4, a grating 22 splits the light emitted from the light source 11 into at least three light beams to detect a tracking error signal using a three-beam method.

FIG. 5 shows the optical structure of the optical pickup, according to a third aspect of the present invention. In the third aspect of the present invention, the optical element 13 is disposed between the light source 11 and the optical path changing device. Specifically, the plate beam splitter 23 and the collimating lens 15 and the beam shaping device 21 are disposed between the plate beam splitter 23 and the objective lens 19. In FIG. 5, the same reference numerals as those in FIGS. 2 and 4 represent the same components, and thus their descriptions will be omitted.

As shown in FIG. 5, in a case where the collimating lens 15 and the beam shaping device 21 are disposed between the plate beam splitter 23 and the objective lens 19, the light which has been reflected from the optical disc 10, passed through the plate beam splitter 23, and proceeded to the light receiving optical system becomes the convergent light.

Thus, the concave lens 27, the so-called Yo-lens that is used to form the light spot having a proper size on the photodetector 29, may be disposed between the plate beam splitter 23 and the photodetector 29.

In a case where the optical pickup has the optical arrangement as shown in FIG. 5 and uses the plate beam splitter 23 as the optical path changing device, the concave lens 27 may be disposed to be inclined in a direction opposite to a direction in which the plate beam splitter 23 is inclined, in order to remove coma aberration generated when the light reflected from the optical disc 10 passes through the plate beam splitter 23.

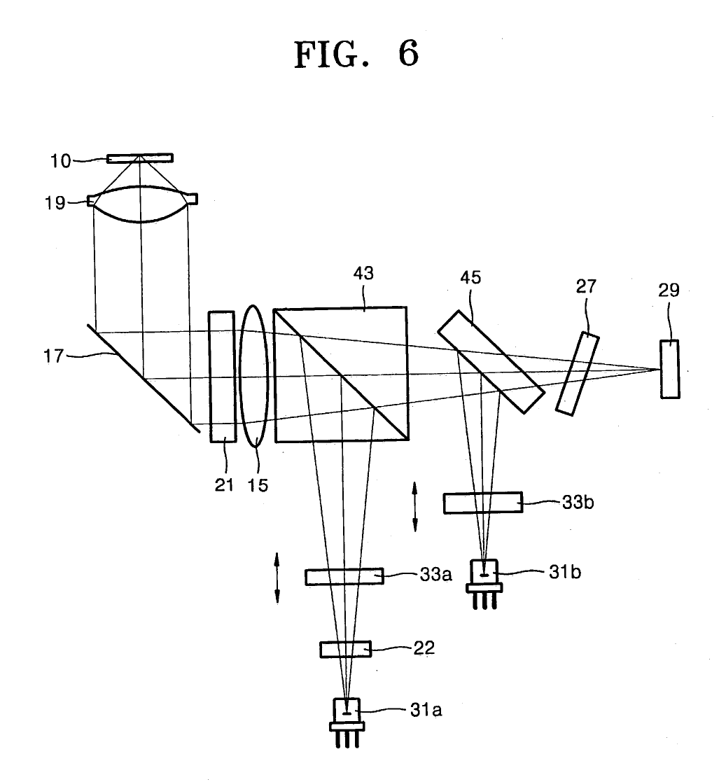

The optical pickup, according to an aspect of the present invention, may include a plurality of light sources, which emit light beams having different wavelengths and a plurality of optical elements which adjust the convergence and/or the divergence of the light beams emitted from the plurality of light sources. Thus, the optical pickup can be configured to a compatible optical pickup that can be applied to a plurality of optical discs having different formats, that is, a plurality of families of optical discs. An optical pickup including the plurality of light sources and the plurality of optical elements is shown in FIG. 6.

FIG. 6 shows the optical structure of the optical pickup, according to a fourth aspect of the present invention. Referring to FIG. 6, the optical pickup, according to the fourth aspect, includes first and second light sources 31a and 31b which emit light beams having different wavelengths, the single photodetector 29, and the single objective lens 19. The optical pickup can be configured to a compatible optical pickup that can be used in both the DVD family optical discs and the CD family optical discs. Further, the collimating lens 15 and the beam shaping device 21 are disposed between a first optical path changing device, which will be described below, and the objective lens 19. In FIG. 6, the same reference numerals as those of the above aspects represent the same components, and thus their descriptions will be omitted.

One of the first and second light sources 31a and 31b emits the light beam having a wavelength of, for example, 655 nm and the other emits the light beam having a wavelength of, for example, 785 nm.

The optical pickup, according to the fourth aspect of the present invention, as shown on FIG. 6, may include two optical elements 33a and 33b which adjust the convergence and/or the divergence of the light beams emitted from the first and second light sources 31a and 31b.

Because the index of refraction of the collimating lens 15 or the index of refraction of optical components disposed between the first and second light sources 31a and 31b and the collimating lens 15 varies depending on the wavelength of the incident light beam, the lengths of the optical paths of the light beams having the different wavelengths emitted from the first and second light sources 31a and 31b are different from each other due to a difference in the index of refraction of the optical components according to the wavelength. As a result, the light beams may be converged or diverged. In the optical pickup, according to the fourth aspect of the present invention, including two light sources 31a and 31b and one collimating lens 15 as shown in FIG. 6, the convergence and/or the divergence of the light beams emitted from the first and second light sources 31a and 31b may be adjusted using the optical elements 33a and 33b because it is not proper that the collimating lens 15 is moved.

Although the optical pickup shown in FIG. 6 includes two optical elements 33a and 33b to adjust the convergence and/or divergence of the light beams emitted from the first and second light sources 31a and 31b, the optical pickup may include only one optical element to adjust the convergence and/or the divergence of any one of the light beams emitted from the first and second light sources 31a and 31b.

For example, the optical pickup according to an aspect of the present invention, includes two light sources and may be applied to be compatible with at least any of the DVD family optical discs and at least any of the CD family optical discs. Further, the optical pickup according to an aspect of the present invention, may be configured such that convergence and/or the divergence of the light beams for the DVD is not adjusted, and convergence and/or the divergence of the light beam for the CD is adjusted.

The grating 22 and the optical element 33a are installed separately in FIG. 6. However, the grating 22 and the optical element 33a may be formed in one united body.

The optical pickup, according to the fourth aspect of the present invention, includes the first optical path changing device for changing the traveling path of the light beam emitted from the first light source 31a and a second optical path changing device for changing the traveling path of the light beam emitted from the second light source 31b. In FIG. 6, a cubic beam splitter 43 is used as the first optical path changing device, and a plate beam splitter 45 is used as the second optical path changing device.

In a case where the plate beam splitter 45 is used as the second optical path changing device, as in FIG. 6, the concave lens 27 may be disposed to be inclined in a direction opposite to a direction in which the plate beam splitter 45 is inclined, in order to remove the coma aberration generated when the light reflected from the optical disc 10 passes through the plate beam splitter 45, as in the above aspects of the present invention.

The optical pickup, according to the second through fourth aspects of the present invention, may include the collimating lens having a short focal length, such as the collimating lens 15 of the first aspect of the invention.

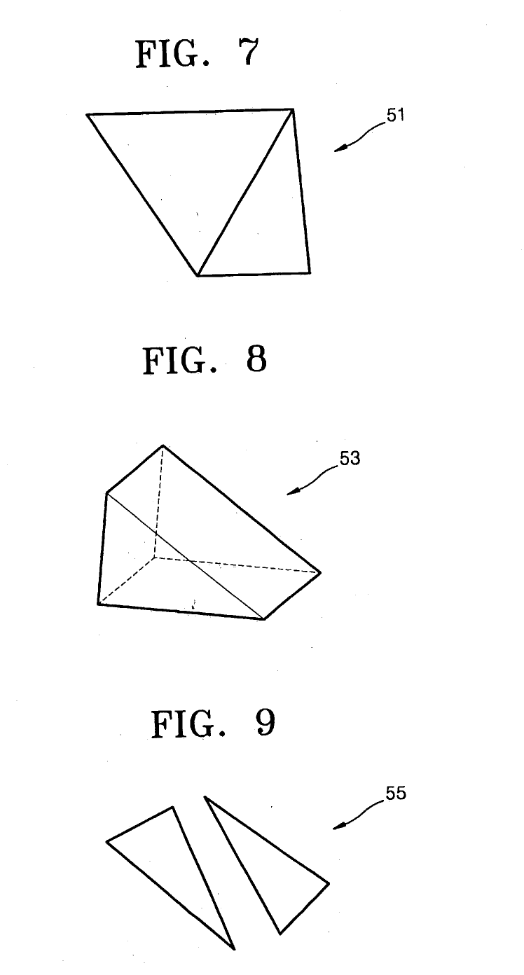

FIGS. 7 through 9 show first through third examples of the beam shaping device 21 used in the optical pickup, according to the second through fourth aspects of the present invention, respectively. Examples of the beam shaping device 21 of the optical pickup, according to an aspect of the present invention, includes beam shaping devices 51, 53, and 55 shown in FIGS. 7 through 9. The beam shaping device, according to an aspect of the present invention, is not limited to the structure of the beam shaping devices shown in FIGS. 7 through 9 and may have various structures known in the art.

The beam shaping device 53 shown in FIG. 8 functions as a reflecting mirror. Thus, in the optical pickup, according to an aspect of the present invention, the beam shaping device 53 is disposed at the position of the reflecting mirror 17, and the reflecting mirror 17 is removed.

As described above, an optical pickup, according to an aspect of the present invention, is a finite optical system including a collimating lens and can manage a parallel light by adjusting the convergence and/or divergence of a light using an optical element. However, the optical pickup according to the present invention is not limited to this. That is, the optical pickup according to the present invention may be a finite optical system including an optical element which adjusts the convergence and/or the divergence of the light. Further, in an aspect of the present invention, the optical element which adjusts the convergence and/or the divergence of the light may be used to generate optical aberration on purpose, if needed.

According to the present invention, because the convergence and/or the divergence of the light is adjusted using a separate optical element, an assembling process of the optical pickup is simple and it is easy to adjust the convergence and/or the divergence of the light.

According to the present invention, the present invention can be applied to an optical system which greatly generates optical aberration by the convergence and/or the divergence of the light, as in a slim optical pickup including a collimating lens having a short focal length or an optical system including an optical component, such as a beam shaping device. Further, the present invention can be applied to an optical recording and/or recording apparatus using the above optical pickup which is necessary to manage the optical aberration.

Although a few preferred embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An optical pickup condenses a light emitted from a light source using an objective lens and irradiates the light on an optical recording medium to record data on the optical recording medium and/or to reproduce the data recorded on the optical recording medium, the optical pickup comprising:
an optical element adjusting a convergence and/or a divergence of the light emitted from the light source and proceeded to the objective lens.

2. The optical pickup of claim 1, wherein the optical element is a hologram optical element that adjusts the convergence and/or the divergence of the incident light.

3. The optical pickup of claim 1, further comprising:
a collimating lens to convert the light emitted from the light source into a parallel light after passing through the collimating lens and the optical element.

4. The optical pickup of claim 3, wherein the collimating lens has a focal length of 14 mm or less.

5. The optical pickup of claim 3, wherein the optical pickup has a slim structure.

6. The optical pickup of claim 3, wherein the optical element is disposed between the light source and the collimating lens.

7. The optical pickup of claim 6, further comprising:
a beam shaping device disposed between the collimating lens and the objective lens to shape the light.

8. The optical pickup of claim 3, further comprising:
a beam shaping device disposed between the collimating lens and the objective lens to shape the light.

9. The optical pickup of claim 3, wherein the light source comprises a plurality of light sources to emit the light having different wavelengths and the optical element adjusts the convergence and/or the divergence of the light emitted from at least one of the plurality of light sources so that the optical pickup is compatible for a plurality of optical recording media having different formats.

10. The optical pickup of claim 1, wherein the optical pickup has a slim structure.

11. The optical pickup of claim 1, wherein the light source comprises a plurality of light sources to emit the light having different wavelengths and the optical element adjusts the convergence and/or the divergence of the light emitted from at least one of the plurality of light sources so that the optical pickup is compatible for a plurality of optical recording media having different formats.

12. An optical recording and/or reproducing apparatus that records data on an optical recording medium and/or reproduces the data recorded on the optical recording medium, the apparatus comprising:
a light source emitting a light;
an objective lens;
an optical pickup condensing the light emitted from the light source using the objective lens and irradiating the light on the optical recording medium,
wherein the optical pickup comprises an optical element to adjust a convergence and/or a divergence of the light emitted from the light source and proceeding to the objective lens.

13. The optical recording and/or reproducing apparatus of claim 12, wherein the optical element is a hologram optical element that adjusts the convergence and/or the divergence of the incident light.

14. The optical recording and/or reproducing apparatus of claim 12, wherein the optical pickup comprises a collimating lens to convert the light emitted from the light source into a parallel light after passing through the collimating lens and the optical element.

15. The optical recording and/or reproducing apparatus of claim 14, wherein the collimating lens has a focal length of 14 mm or less.

16. The optical recording and/or reproducing apparatus of claim 14, wherein the optical pickup has a slim structure.

17. The optical recording and/or reproducing apparatus of claim 14, wherein the optical element is disposed between the light source and the collimating lens.

18. The optical recording and/or reproducing apparatus of claim 17, wherein the optical pickup further comprises a beam shaping device disposed between the collimating lens and the objective lens to shape the light.

19. The optical recording and/or reproducing apparatus of claim 14, wherein the optical pickup further comprises a beam shaping device disposed between the collimating lens and the objective lens to shape the light.

20. The optical recording and/or reproducing apparatus of claim 14, wherein the light source comprises a plurality of light sources to emit the light having different wavelengths and the optical element adjusts the convergence and/or the divergence of the light emitted from at least one of the plurality of light sources so that the optical pickup is compatible for a plurality of optical recording media having different formats.

21. The optical recording and/or reproducing apparatus of claim 12, wherein the optical pickup has a slim structure.

22. The optical recording and/or reproducing apparatus of claim 12, wherein the light source comprises a plurality of light sources to emit the light having different wavelengths and the optical element adjusts the convergence and/or the divergence of light emitted from at least one of the plurality of light sources so that the optical pickup is compatible for a plurality of optical recording media having different formats.

23. An optical pickup of an optical disc, comprising:
a light source emitting a light;
an objective lens focusing the light emitted from the light source and irradiating the light on the optical disc;
a collimating lens making the light emitted from the light source into a parallel light; and
an optical element adjusting a convergence and/or a divergence of the light so that the light passing through the collimating lens and proceeding to the objective lens is a parallel light or approximate to the parallel light.

24. The optical pickup of claim 23, wherein the light source comprises an edge emitting laser or a vertical cavity surface emitting laser to emit the light having a predetermined wavelength.

25. The optical pickup of claim 23, further comprising:
an optical path changing device, wherein the collimating lens is disposed between the light source and the optical path changing device or between the optical path changing device and the objective lens so that the collimating lens focuses the divergent light emitted from the light source and makes the light into the parallel light.

26. The optical pickup of claim 23, wherein the collimating lens comprises a short focal length of 14 mm or less.

27. The optical pickup of claim 23, wherein the optical element comprises a hologram optical element disposed between the light source and the collimating lens.

28. The optical pickup of claim 23, wherein the light source emits the light having a wavelength of 655 nm and the objective lens comprises a numerical aperture of 0.6 or 0.65.

29. The optical pickup of claim 23, further comprising:
an optical path changing device, wherein the optical element and the collimating lens are disposed between the light source and the optical path changing device.

30. The optical pickup of claim 29, wherein the optical path changing device comprises a plate beam splitter.

31. The optical pickup of claim 30, further comprising:
a beam shaping device shaping the light, wherein the beam shaping device is disposed on an optical path of the light converted into the parallel light after passing though the optical element and the collimating lens.

32. The optical pickup of claim 31, wherein the collimating lens and the beam shaping device are disposed between the light source and the plate beam splitter so that the light reflected from the optical disc and passing through the plate beam splitter becomes the parallel light in a beam shaping state.

33. The optical pickup of claim 32, further comprising:
a grating splitting the light emitted from the light source into at least three light beams to detect a tracking error signal using a three-beam method.

34. The optical pickup of claim 33, further comprising:
a plate beam splitter; and
an optical path changing device, wherein the plate beam splitter, the collimating lens, and the beam shaping device are disposed between the plate beam splitter and the objective lens so that the light reflected from the optical disc, and passed through the plate beam splitter becomes the convergent light.

35. The optical pickup of claim 34, further comprising:
a photodetector; and
a concave lens forming a light spot on the photodetector and disposed between the plate beam splitter and the photodetector and inclined in a direction opposite to a direction in which the plate beam splitter is inclined, to remove coma aberration generated when the light reflected from the optical disc passes through the plate beam splitter.

36. The optical pickup of claim 33, wherein the grating and the optical element are installed separately.

37. The optical pickup of claim 33, wherein the grating and the optical element are formed in one united body.
